(19) United States
(12) Patent Application Publication
(10) Pub. No.: US 2011/0298215 A1
(43) Pub. Date: Dec. 8, 2011

(54) NEAR SHORE WEC SYSTEM

(76) Inventors: Hein Wille, Saint Michel (FR); Sophie Boureau, Nice (FR)

(21) Appl. No.: 13/109,743

(22) Filed: May 17, 2011

Related U.S. Application Data
(60) Provisional application No. 61/351,730, filed on Jun. 4, 2010.

(51) Int. Cl. F03B 13/18; H02N 2/18

(52) U.S. Cl. 290/53; 310/339

(57) ABSTRACT

Systems are described for obtaining energy from water movements in shallow waters, using panels (4) that are pivotally mounted (13) near the sea floor in shallow water and that extend up to the sea surface, or that are pivotally mounted above the sea surface and extend down into the sea. As water near the sea surface moves in ellipses (48), or largely back and forth, the panel pivots back and forth. A cylinder (8, 18) with one end (7′) mounted on a stationary base and an opposite end (7) connected to the panel, carries at least one sheet (70) of elastomeric material that has electrodes (72, 74) at its opposite faces, with an electrical charge between the electrodes. As the panel pivots back and forth, the sheet is repeatedly stretched and relaxed to vary the voltage between the electrodes in order to generate electricity. A cylinder (8) can be used whose ends move toward and away from each other, or a cylinder (18) can be used whose ends pivot about a cylinder axis relative to each other.

### CROSS-REFERENCE

Applicant claims priority from US provisional patent application Ser. No. 61/351,730 filed Jun. 4, 2010.

### BACKGROUND OF THE INVENTION

The present invention relates to systems for generating electrical power by extracting energy from waves in shallow water that is usually near shore. The system uses panels or floats that are repeatedly pivoted back and forth to stretch and relax sheets of elastomeric material such as SSM (synthetic stretchable material), to thereby vary the voltage between electrodes lying at opposite faces of the sheet.

There have been recent developments of SSM (synthetic stretchable material) in the form of sheets of elastomeric material such as EAP (electro active polymers) which generates electricity when electrodes at opposite faces of the sheet contain opposite electrostatic charges and the distance between the faces changes, as when it is stretched (or possibly compressed). Such synthetic stretchable material is described in U.S. Pat. Nos. 6,768,246 and 7,166,953 by Pelrine; 6,812,624 by Pei; and 7,038,357 by Goldenberg; and US publication 2001/0029401 by Ishido. Applicant provides systems for generating electricity from wave energy, using stretching and/or relaxing or compression of SSM.

### SUMMARY OF THE INVENTION

In accordance with one embodiment of the present invention, systems are provided for producing electricity from wave, or near-surface current energy, using panels that are pivoted back and forth to stretch and relax sheets of elastomeric material. Each system includes a base anchored to a sea bed, a panel pivotally connected to the base to oscillate back and forth in response to current motion acting on faces of the panel, and power extraction means for extracting energy from movements of the panel. The power extraction means includes at least one capacitor cylinder having opposite ends, with one end connected to the base and an opposite end connected to the panel, to stretch and relax (or compress and decompress) sheets of elastomeric material such as sheets of SSM (synthetic stretchable material). Electrodes lying at opposite faces of the sheet carry electric charges, with the voltage between the electrodes varying as the sheet is stretched and relaxed or compressed and relaxed, and with the varying voltage being used to generate electrical power.

In one system, the base has a base support lying near the sea floor and panels extend upward from the base to the sea surface. In another system, the base has a base support lying above the sea surface and panels hang from the support into the sea. In another system, floating bodies are used instead of panels.

The novel features of the invention are set forth with particularity in the appended claims. The invention will be best understood from the following description when read in conjunction with the accompanying drawings.

### BRIEF DESCRIPTION OF THE DRAWINGS

FIG. 1A is an end elevation view of a wave power generating system of the invention wherein opposite ends of a capacitor cylinder move towards and away from each other.

FIG. 1B is a sectional view of a modified wave power generating system of the invention which includes capacitor cylinders beyond both opposite faces of the panel.

FIG. 2 is a right side elevation view of the system of FIG. 1.

FIG. 3 is an end elevation view of a wave power generating system of another embodiment of the invention, wherein opposite ends of a capacitor cylinder pivot about the cylinder axis relative to each other.

FIG. 4 is a right side view of the system of FIG. 3.

FIG. 5 is an end elevation view of another wave power generating system of the invention wherein an upper end of a panel is pivotally mounted on an above-sea base support and extends downward therefrom.

FIG. 6 is a side elevation view of the system of FIG. 5.

FIG. 7 is an end elevation view of a wave power generating system of another embodiment of the invention wherein the base floats and is anchored to the sea floor by mooring lines, and the panel hangs from the base.

FIG. 8 is a side elevation view of the system of FIG. 7.

FIG. 9 is a front elevation view of a system that includes several sub-systems of the type shown in FIGS. 7 and 8.

FIG. 10 is a sectional view of a wave power generating system of another embodiment of the invention wherein the base is fixed and extends above the sea surface.

FIG. 11 is a sectional view of another system of the invention wherein the base extends above the sea surface.

FIG. 12 is a front view of a wave generating system of another embodiment of the invention that includes buoys that float on the sea surface.

FIG. 13A is a partial sectional view of a capacitor cylinder such as shown in FIG. 1.

FIG. 13B is a partial sectional view taken on line 13B-13B of FIG. 13A.

FIG. 14 is a partial isometric view of a capacitor cylindrical of another construction that can be used in the cylinder of FIG. 1.

FIG. 14A is a sectional view of the cylinder of FIG. 14A.

FIG. 14B is a view similar to FIG. 14A but with discs of the cylinder compressed more than in FIG. 14A.

FIG. 15 is a sectional view of a capacitor cylinder of another construction that can be used in the cylinder of FIG. 3.

FIG. 15A is a partial sectional view of the cylinder of FIG. 15.

FIG. 16 is a partial isometric view of a capacitor cylinder of another construction that can be used in the cylinder of FIG. 3.

FIG. 17 is a sectional view of a portion of the capacitor cylinder of FIG. 16.

### DESCRIPTION OF THE PREFERRED EMBODIMENTS

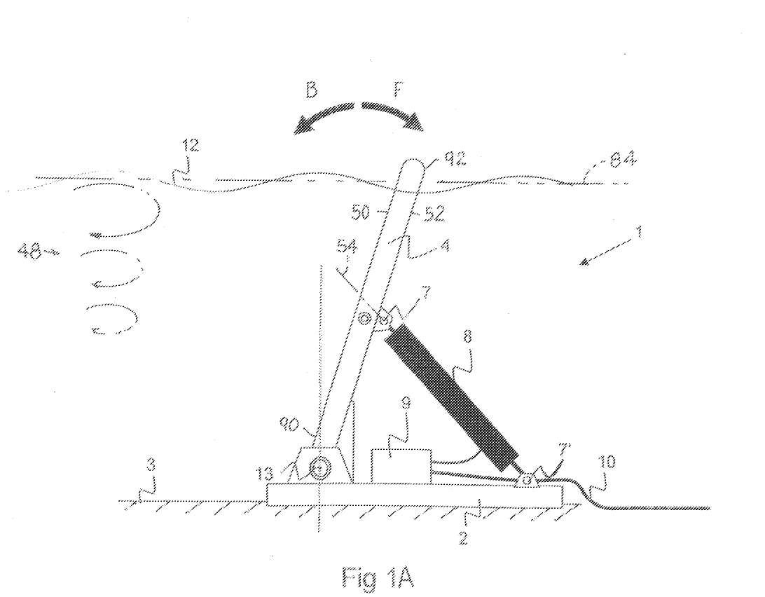

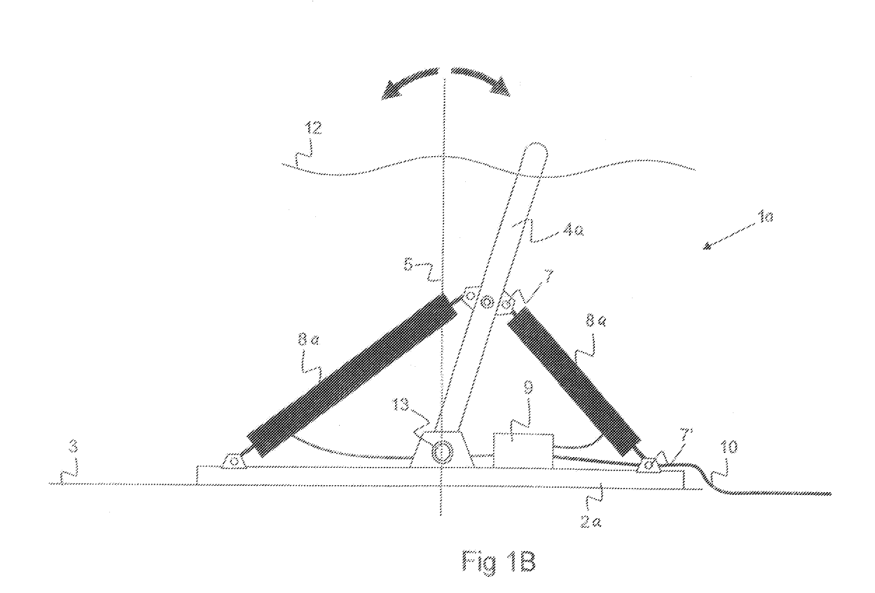

FIG. 1A shows a wave, or water current power generating system 1 of the invention which includes a base 2 lying on the sea floor 3 in a region of shallow waters. The base 2 is pivotally connected at axis 13 to an upstanding panel 4. The panel oscillates backwards and forwards B, F in response to shallow currents acting on panel faces 50, 52. A cylinder 8 lies on a cylinder axis 54 and has opposite ends 7′, 7 connected respectively to a support of the base 2 and to the panel 4. Each cylinder end is spaced from the panel pivot axis 13 by at least 5% and preferably at least 10% of the distance between the panel top and bottom ends. The cylinder includes one or more sheets of elastomeric material with electrodes at opposite faces of the sheet. As the panel 4 oscillates under current action, it will either stretch and then relax stretching of the sheet, or compress and relax compression of the sheet. By elongating or compressing the sheet, the cylinder converts energy from shallow current into electricity via a power control unit 9 on the base 2. An electric cable 10 extending from the power control unit 9 delivers electricity to users. The cylinder, or capacitor cylinder holds or is attached to capacitor devices that hold charges under voltages that vary as cylinder locations such as cylinder opposite ends move toward and away from each other or pivot relative to each other.

FIG. 13A shows a portion of a cylinder 60 that can be used as the cylinder 8 of FIG. 1A. The cylinder 60 of FIG. 13A contains power extraction means in the form of variable voltage capacitor devices 62, 64, 66 that are each in the form of a tube. FIG. 13B shows that each capacitor device such as 62 includes a sheet 70 of elastomeric material and a pair of electrodes 72, 74 lying against opposite faces of the sheet. The electrodes are preferably stretchable to follow stretching of the elastomeric sheet 70. FIG. 13B also shows elastomeric protective layers 76 on the electrodes. An elastomeric material can be defined as one with a Young's modules of elasticity of no more than 1.0 GPa.

There are electrical charges of different voltages on the electrodes 72, 74. If the sheet 70 is stretched so its thickness decreases from T1 to T2, then the electrodes move closer together and, for the same electric charge, the voltage between the electrodes decreases. When the stretching is relaxed, so the sheet thickness increases, the voltage increases. It is preferred that the sheet 70 always be pre-stretched somewhat, so relaxation of the sheet results in less stretching. Changes in voltage across the sheet 70 can be used to generate electrical power, as is described in detail in US publication 2010/0314871.

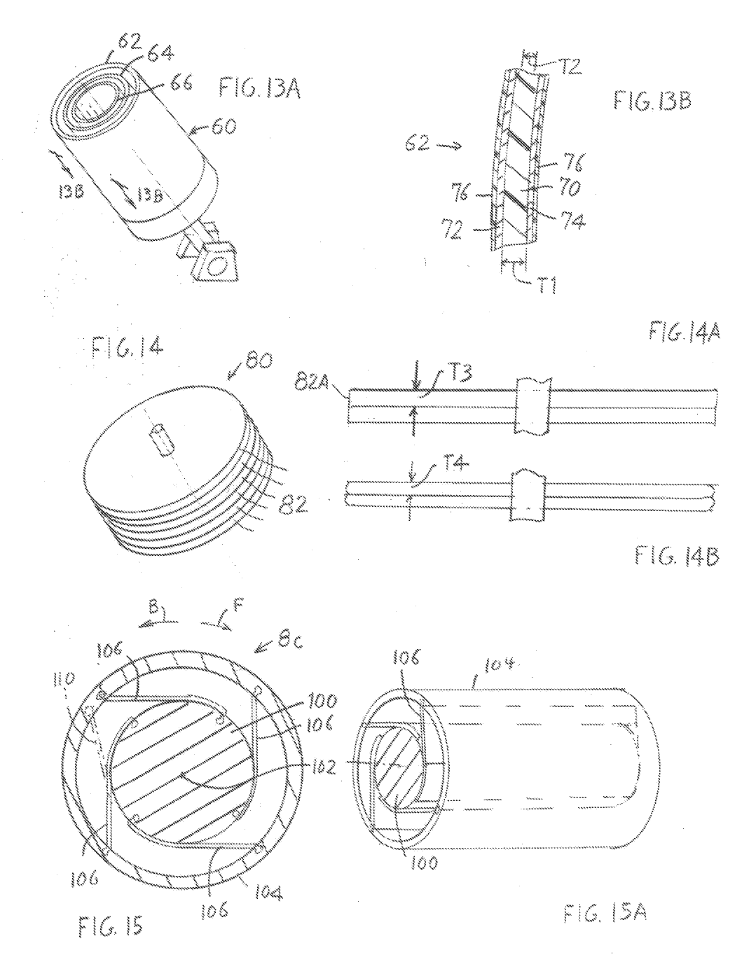

FIG. 14 shows a portion of another cylinder 80 that can be used as the cylinder 8 of FIG. 1A. The cylinder 80 includes a stack of capacitor device 82 that each includes a plate, or sheet, of elastomeric material and a pair of electrodes lying against opposite faces of the sheet. The construction can be as shown in FIG. 13B but without the curvature shown. FIG. 14A shows a pair of capacitor devices 82A, each of a thickness T3, before they are fully compressed. FIG. 14B shows the capacitor devices after they are compressed to the thickness T4. The compression to T4 decreases the voltage between the electrodes lying at opposite faces of each sheet of elastomeric material. Compression of the compressible cylinder 80 of FIG. 14 is obtained by opposite ends 7, 7′ (FIG. 1a) of the cylinder being moved toward each other when the panel 4 swings forward F.

FIG. 1B shows another system 1a that is similar to the system of FIG. 1a but that includes a pair of cylinders 8a that each has one end pivotally mounted on a base 2a and an opposite end pivotally connected to the panel 4a. The cylinders 8, which lie on opposite sides of the panel, are preferably pre-stressed in cases where the elastomeric sheet (70, FIG. 13B) of the capacitor device(s) are prestretched and relaxed (to only reduce the stretching). As the panel 4a of FIG. 1B oscillates on opposite side of a vertical line 5, the elastomeric sheet of a cylinder on one side will relax and the sheet of a cylinder on the other side will be stretched even more. The electrical output of each of the cylinders may vary sinusoidally. However, when the voltage outputs of the two cylinders are added the sum voltage varies less because when one voltage output is increasing the other voltage output is decreasing. It is usually easier to utilize a voltage output that varies only moderately, rather than one that varies greatly and at an unpredictable rate. The voltage outputs of the two cylinders vary simultaneously and are 180° out of phase, so their sum varies only moderately and in a repeated and largely predictable manner.

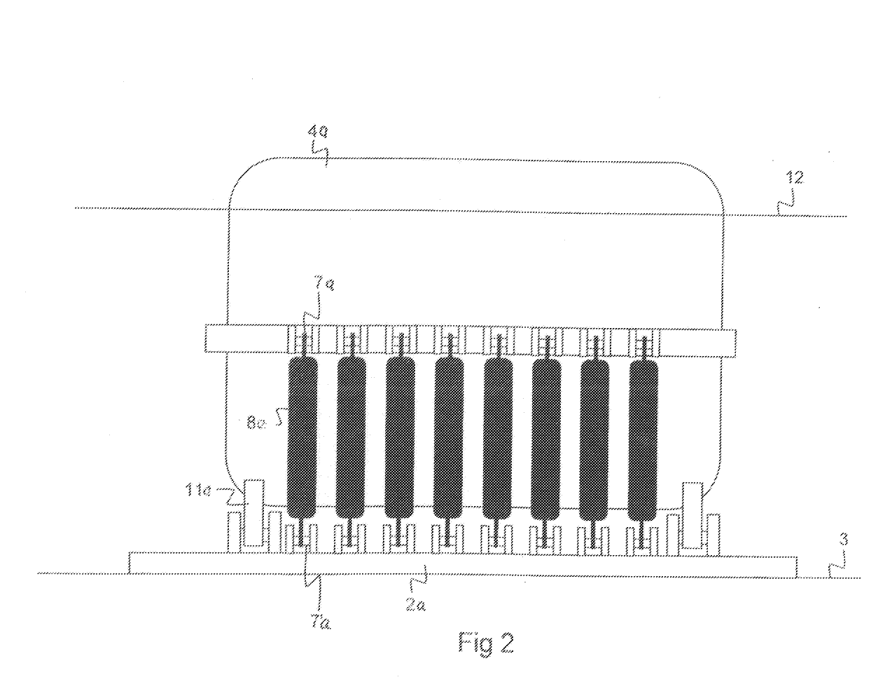

FIG. 2 represents the front view of the wave power generating systems of FIG. 1A and 1B. The system includes several cylinders 8a spaced apart along the length of the base 2a and along the horizontal length of the panel 4a. Each cylinder 8a is attached at one end 7a to the panel 4 and at the other end 7a′ to the base 2a that is fixed on the seabed 3. The panel 4a is pivotally attached to the base 2a via pivot joints 11a. A minority of the panel is above sea level 12.

In shallow waters (under 100 meters depth), water near but below the sea surface moves in ellipses that have a large horizontal component, as indicated at 48 in FIG. 1A. Such wave, or current movement is greatest just below the sea surface and decreases at increasing depth. Such current action is described in PCT WO2004/097212. In order for applicant to obtain maximum panel movement, the panel 4 of FIG. 1A extends to at least the mid tide sea level 84 which is the average sea level. While the bottom 90 of the panel lies near the sea floor, the top 92 of the panel preferably extends slightly above the sea surface 12 level. This allows the panel to be pushed by wave currents 48 lying immediately below the sea surface, even when the panel has tilted from the vertical. This also allows persons on boats to see the tips of the panels to avoid a crash.

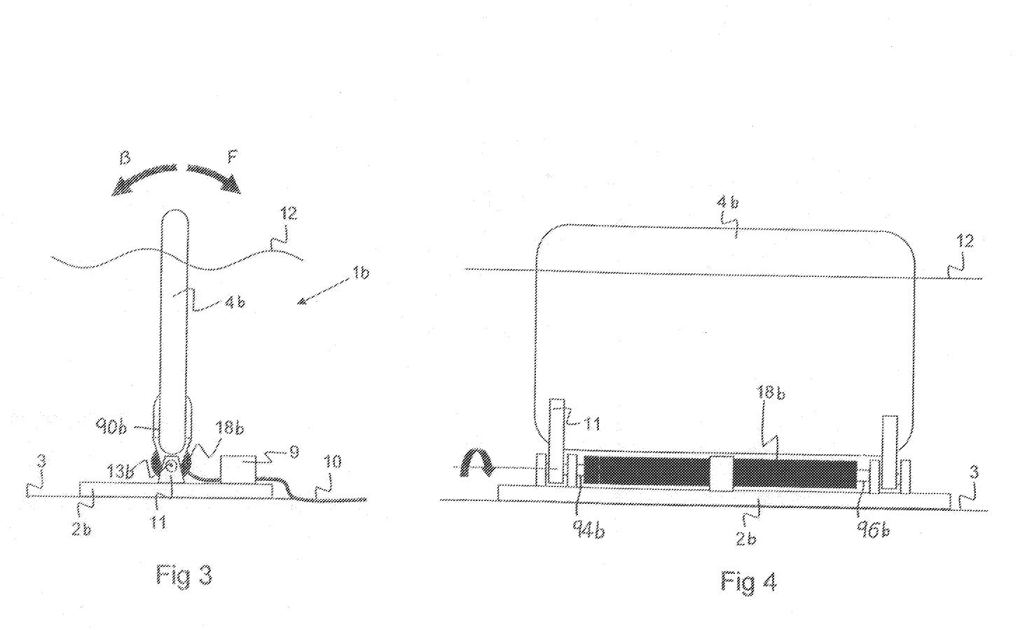

FIG. 3 shows a sectional view of another power generating system of the invention. In this embodiment, as in the ones previously shown, the base 2b lies on the sea floor 3. The base is pivotally attached to the bottom 90b of an upstanding panel 4b about a primarily horizontal axis 13b. The panel is able to oscillate, in use, backwards and forwards about axis 13b in response to shallow current motion acting on faces of the panel (as indicated by arrows B, F). In this embodiment, the cylinder 18b has one end 94b (FIG. 4) fixed to the stationary base 2b and an opposite end 96b that is fixed to the pivoting panel 4b.

As the panel 4b oscillates under shallow current action, the panel applies a torsion force to a capacitor device in the cylinder 18b. The increase and decrease of torsion as the panel pivots is used to convert energy from currents into electricity via a power control unit 9 placed on the base 2b and an electric cable 10 that delivers the electricity to users.

FIGS. 15 and 15A show one construction of a cylinder 18c that can be used in place of the cylinder 18b of FIG. 3 to extract electrical energy from rotation of a first end of the cylinder relative to an opposite second end. The cylinder 18c includes a pivoting shaft 100 that lies on the cylinder axis 102 and that is connected to the pivoting panel (4b of FIG. 3), and a stationary tube 104 that is fixed to the base. A plurality of capacitor devices 106 each extends between the pivoting shaft 100 and the tube 104. Each capacitor device 106 includes a sheet of elastomeric material that is stretched when the shaft 100 pivots in direction F while the tube 104 remains fixed to the base and does not pivot. It is possible to mount one or more capacitor devices as shown at 110 to be stretched when the panel and shaft 100 pivot in direction B, and to prestretch all capacitor device. By the use of capacitor devices such as 106, 110 that extend in opposite directions, the devices can be mounted in prestretched positions.

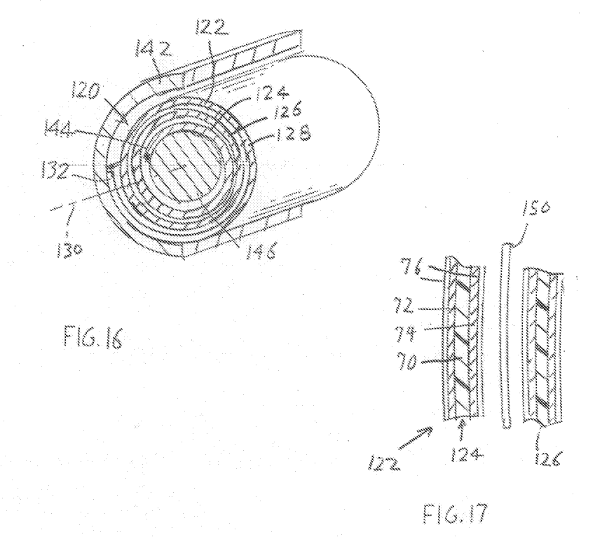

FIG. 16 shows another capacitor device 120 that can be used in place of the cylinder 18b of FIG. 3 to extract electrical energy from relative rotation of opposite ends of the cylinder. The capacitor device 120 includes a multi-layer sheet 122 of elastomeric material that is wrapped in at least one turn, and preferably a plurality of turns 124, 126, 128 in a spiral about an axis 130. The radially outer edge 132 of the multi-layer sheet is fixed to a tube 142 that is fixed to the fixed end of the cylinder. The radially inner edge 144 of the wrap is fixed to a shaft 146 that pivots as a panel pivots.

FIG. 17 shows that the multi-layer sheet 122 has the construction of the capacitor device of FIG. 13B, including an elastomeric sheet 70, electrodes 72, 74, and elastomeric protective layers 76. A sheet 150 of low friction material (e.g. Teflon) lies between adjacent turns such as 124, 126.

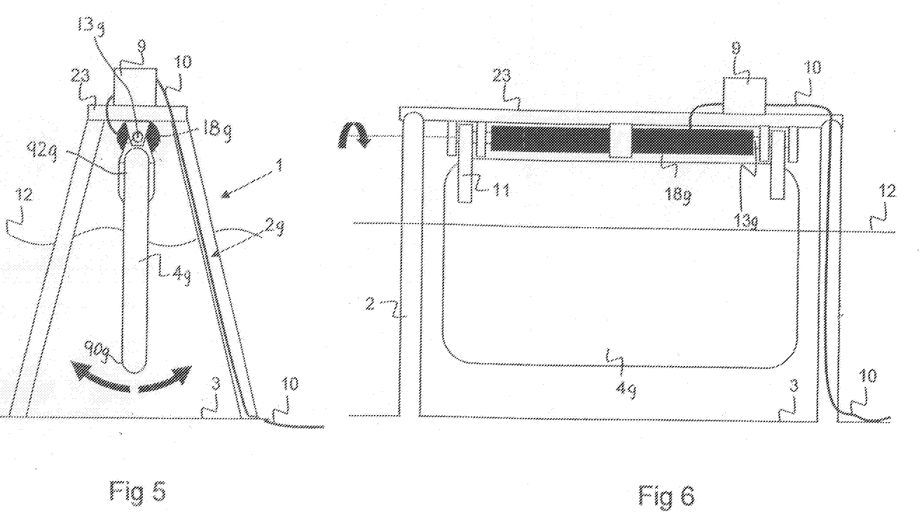

FIG. 5 shows another shallow current power generating system in which the pivoting panel 4g hangs from a support 23 of a base 2g. The upper end 92g of the panel 4g preferably lies above the sea surface. A majority of the panel height lying between the panel ends 90g, 92g, lies under the sea surface 12. A cylinder 18g that extracts electrical energy from panel pivoting, has one cylinder end fixed to the support 23 and an opposite cylinder end fixed to the panel, with both ends lying on the cylinder axis 13g.

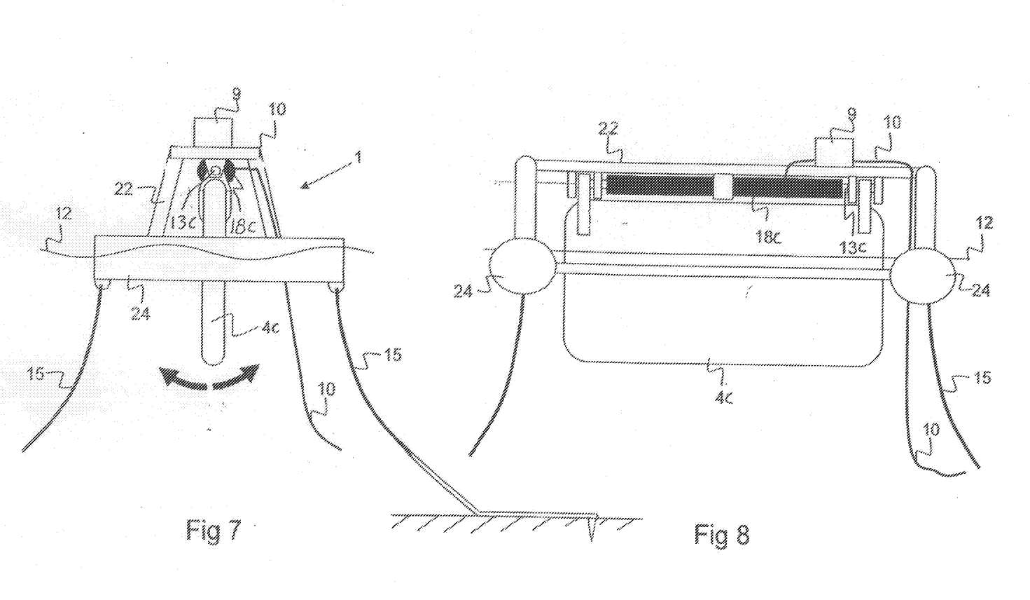

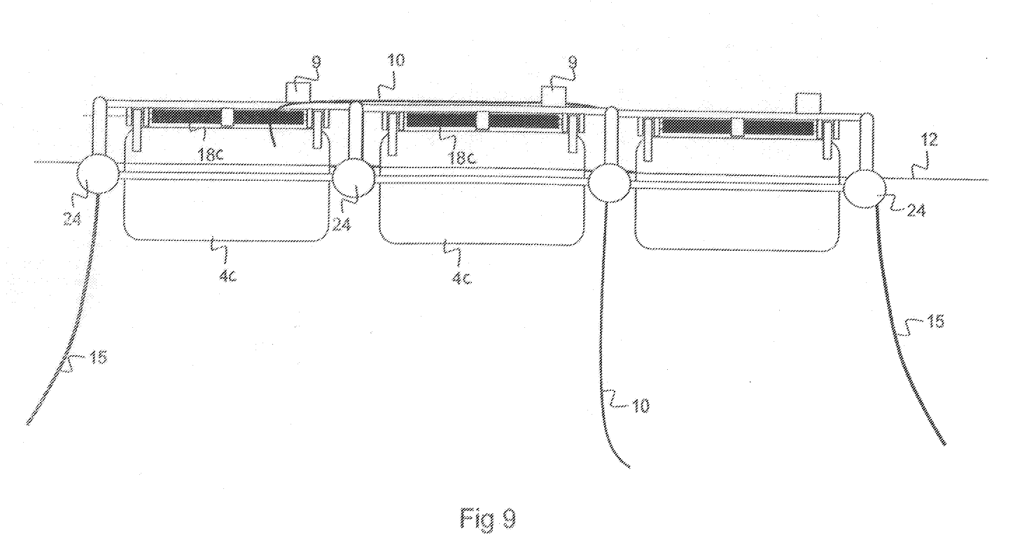

FIGS. 7 shows another power generating system of the invention wherein the base 24 is buoyant and is anchored to the sea floor by mooring lines 15 that limit drift of the base from an initial location. The figures show catenary lines, but other line shapes or even rigid posts can be used. The base has a support 22 that supports the top end of a panel 4c about a primarily horizontal axis 13c so the panel hangs therefrom with most of the panel lying under water level to be exposed to wave action. A cylinder 18c for converting motion to electricity, has an axis 13c lying on the cylinder axis and may be of the types described above for the cylinder of FIG. 3. FIGS. 8 and 9 show that the system generally includes a plurality of panels and corresponding cylinders.

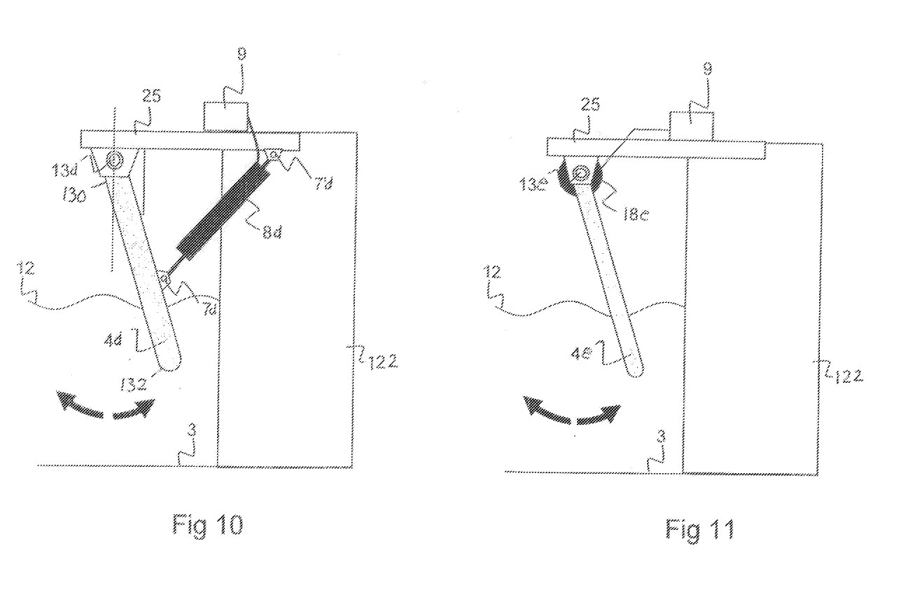

FIG. 10 shows a system wherein the base 122 is fixed to the sea bed 3 and has a base portion 25 lying above the sea surface 12. A panel 4d hangs from the base and has an upper end 130 lying above the sea surface and a lower end 132 lying at least one meter below the sea surface. A cylinder 8d has opposite ends 7d, 7′d with one end 7′d connected to the base at a location spaced from the panel axis 13d, and has an opposite end 7d connected to the panel at a location spaced from the panel axis 13d. FIG. 11 shows a system similar to FIG. 10, except that the cylinder 18e has one end fixed to the base and an opposite end connected to the panel, with one cylinder end pivotable about the axis 13e of the panel 4e.

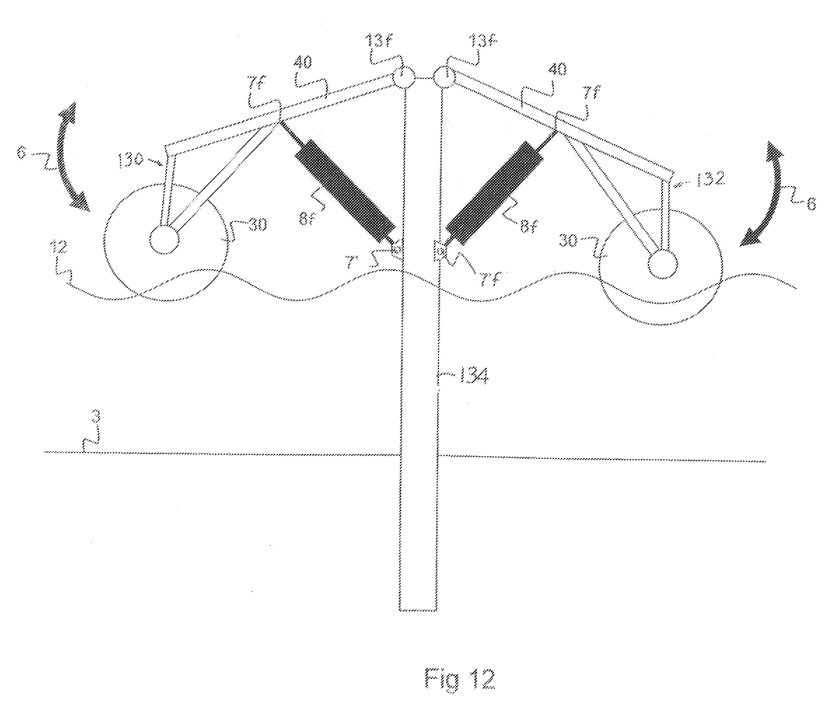

FIG. 12 is a front view of a power generating system of another embodiment of the invention wherein two buoyancy modules 130, 132 at the sea surface are connected to a base 134 that is anchored to the sea to limit drift to zero drift. Each buoyancy module includes a buoyant body 30 that floats on the sea surface 12 and a pivoting frame 40. The frames oscillate up and down about corresponding primarily horizontal axes 13f. Cylinders 8f extend between the pivoting frames 40 and the base 134. The cylinders 18f can be of the types shown in FIGS. 13A or 14 wherein opposite ends 7f, 7′f of each cylinder move toward and away from each other. As an alternative, cylinders can be used that each lies on a pivot axis and is of the type shown in FIG. 15.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. Apparatus for converting energy of sea currents that move largely horizontally below the sea surface into electrical energy, comprising:
a base (2) and means for anchoring said base to the sea floor to limit drift of the base;
a panel (4) that lies at least partially in said sea and that is pivotally mounted on said base to oscillate between spaced panel positions when moved by the currents, said panel having top and bottom panel ends (92, 96) with one of said panel ends pivotally mounted about a first primarily horizontal panel axis on said base and with the other panel end being free to move;
said panel top end lies at least as high as the mid tide sea surface level (84) during at least part of said panel oscillations; and
electric power extraction means for converting said back and forth pivoting of said panel into electricity.

2. The apparatus described in claim 1 wherein:
said power extraction means includes a cylinder (8, 18) that has opposite ends (7, 7′) that move relative to each other as a result of pivoting of said panel, and at least one sheet (70) of elastomeric material with electrodes (72, 74) at its opposite sheet faces that forms a capacitor;
means coupled to said sheet and to said opposite cylinder ends for repeatedly changing the thickness (T1, T2) of said sheet to vary the capacitance of said capacitor as said cylinder opposite ends move relative to each other, to thereby vary the voltage between said electrodes, and means responsive to said varying voltage for generating electrical energy.

3. The apparatus described in claim 1 wherein:
said power extraction means includes a cylinder (8) that has opposite ends (7, 7′) including a first cylinder end (71) mounted on said base at a location that is spaced from said first panel axis (13) by a distance of at least 5% of the span between said panel top and bottom ends, and including a second cylinder end (7) that is connected to said panel at a location spaced from said panel axis by at least said distance, so said cylinder ends move together and apart as said panel oscillates;
said power extraction means includes at least one sheet (70) of elastomeric material and electrodes (72, 74) lying at opposite faces of the sheet with an electrical charge between said electrodes, said sheet positioned to decrease and increase in sheet thickness (T1, T2) when said cylinder ends are moved together and apart, to generate a varying voltage between said sheet opposite faces.

4. The apparatus described in claim 2 wherein:
said panel has opposite panel faces (50, 52);
said power extraction means includes a second cylinder device (FIG. 1B) having one cylinder device end pivotally connected to said base and an opposite cylinder device end connected to said panel, with each device end spaced from said first panel axis (13), said cylinder and said second cylinder device lying beyond opposite faces of said panel.

5. The apparatus described in claim 1 wherein:
said power extraction means includes a cylinder (18b, 18g, 18c, 18a, 18e) with opposite cylinder ends and with a cylinder axis (13b) extending between said cylinder ends, said cylinder ends being pivotable relative to each other about said cylinder axis, with a first of said cylinder ends connected to said base to resist pivoting about said cylinder axis and with a second of said cylinder second ends coupled to said panel, so pivoting of said panel results in generating a torque between said cylinder ends, said power extraction means constructed to convert said torque into electrical energy.

6. The apparatus described in claim 1 wherein:
said panel top end (92g) is pivotally mounted about a primarily horizontal axis (13g) on said base, with said primarily horizontal axis lying at least as high as said mid tide sea surface level, with said panel (4g) extending primarily downward from said primarily horizontal axis to a height below the sea surface level and above the sea floor.

7. The apparatus describes in claim 1 wherein:
said base floats on the sea surface, and including means for anchoring the base that includes at least one line (15) that extends from the base to the sea floor and that is fixed to the sea floor.

8. The apparatus described in claim 1 wherein:
said base is fixed to the sea floor and said base has a support portion that lies at least as high as the sea surface, with said first panel axis (13c, 13d) lying above the sea surface and with a panel lower end lying below the sea surface.

9. Apparatus for converting the energy of currents that move with horizontal components below the sea surface, into electrical energy, comprising:
a base and means for anchoring said base to the sea floor to limit its drift from a predetermined location over the sea floor;
a panel that lies at least partially in said sea and that is moveably mounted on said base to oscillate between spaced panel positions when moved by said currents;
a sheet of elastomeric material that has opposite faces and electrodes at said opposite faces with said electrodes having a voltage between them;
and means for varying the thickness of said sheet in response to oscillations of said panel between said panel positions.

10. The apparatus described in claim 9 wherein:
said panel is pivotally mounted on said base at a position wherein a portion of said panel passes through said currents when moving between said spaced panel positions.

11. The apparatus described in claim 10 wherein:
said panel has upper and lower ends, said panel is pivotally mounted on said base mount portion about a primarily horizontal axis that lies at least as high as said sea surface, with said panel extending primarily downward from said axis.

12. Apparatus for converting energy of sea waves into electrical energy, comprising:
a base and means for anchoring said base to the sea floor to limit drift of the base;
at least one float that floats on the sea surface;
a float frame pivotally mounted on said base and attached to said float to allow said float to move up and down on the sea;
electric power extraction means which includes a cylinder that has opposite ends that are moved relative to each other by pivotal motion of said float frame, and a sheet of elastomeric material that has electrodes at its opposite sheet faces to form a capacitor and with said electrodes carrying electric charges to produce a voltage between said electrodes.

13. Apparatus for converting energy of sea waves into electrical energy, comprising:
a base (2) and means for anchoring said base to the sea floor to limit drift of the base;
a panel (4) that lies at least partially in said sea and that is pivotally mounted on said base to pivot back and forth between spaced panel positions when moved by the waves;
a pair of capacitor devices that each includes a sheet of elastomeric material and a pair of electrodes that lie at opposite faces of the sheet, with the sheet of each capacitor device being stretched and with a voltage between the corresponding pair of electrodes;
said capacitor devices each being coupled to said panel so pivoting of the panel changes the amount of stretching of the sheets of the capacitor devices, with said pair of capacitors coupled to said panel so that when stretching of the sheet of a first of said capacitor devices is increased, stretching of the sheet of the other of said capacitors is decreased, and vice versa.
